(19) United States
(12) Patent Application Publication
(10) Pub. No.: US 2022/0410295 A1
(43) Pub. Date: Dec. 29, 2022

(54) METHOD FOR MANUFACTURING A RACK COMPRISING VARIABLE-PITCH TOOTHING IMPLEMENTING A ROUGHING STEP FOLLOWED BY A FINISHING STEP AND A HELICAL BROACHING TOOL

(71) Applicant: JTEKT EUROPE, Irigny (FR)

(72) Inventors: Daniel KESSLER, Decines Charpieu (FR); Pascal VIZIER, St Genis Laval (FR); Emeric RICHARD-VITTON, Lyon (FR)

(73) Assignee: JTEKT EUROPE, Irigny (FR)

(21) Appl. No.: 17/779,083

(22) PCT Filed: Nov. 24, 2020
(86) PCT No.: PCT/FR2020/052161

§ 371 Date: May 23, 2022

(30) Foreign Application Priority Data
Nov. 28, 2019 (FR) FR1913384

(51) Int. Cl. B23F 15/00; B23F 21/26

(52) U.S. Cl. CPC B23F 15/00; B23F 21/26

(57) ABSTRACT

A method for manufacturing a rack including a toothing with variable pitch includes a roughing step, in which a blank of the rack is produced, the blank including at least one extra thickness on at least one zone of the toothing compared to a desired dimensional feature of the rack. The method also includes a finishing step, in which the at least one extra thickness of the blank is removed.

The present invention concerns the methods for manufacturing racks, that is to say toothed bars, which are intended for example for power steering mechanisms used in vehicles.

A rack is a toothed bar comprising, on the one hand a toothing formed of teeth, and on the other hand a back of the toothing opposite to the toothing. Further, a tooth comprises a first flank and a second flank, generally symmetrical to the first flank with respect to an apex connecting the first flank to the second flank.

In certain applications, it is useful to have a variable-pitch rack, that is to say whose toothing has a pitch (distance between two successive teeth) which is not constant.

Such a variable pitch in fact makes it possible to confer a variable reduction ratio between the rack and a pinion which meshes therewith.

Thus, for example, a rack using a smaller pitch, that is to say teeth closer together, in the middle and larger at the ends of said rack, a progressiveness of the power steering control is obtained, which is more precise in the vicinity of the straight line, for small displacements of the steering wheel, and faster during large displacements of the steering wheel, when cornering or parking manoeuvres.

The flanks of the teeth of the variable-pitch racks are not rectilinear but have a helix angle, that is to say a radius of curvature, which is not constant or variable.

To manufacture such racks, several methods are known, such as a forging method, or a machining method using a cutting tool.

Such methods generally give satisfactory results. However, it is very difficult to adjust the parameters of the various methods in order to obtain a rack respecting the desired dimensional characteristics such as, for example, precision of the pitch, of a radial compound also called «teeth space runout» and corresponding to the variation in center distance measured with a so-called perfect MASTER pinion, a pressure angle, and the helix angle of the rack.

Thus, the implementation of such methods requires a particularly long adjustment time in order to obtain racks corresponding to the expected standard.

The objects assigned to the invention are therefore aimed at proposing a method for manufacturing racks with variable-pitch toothing which allows rapid, precise and easily adjustable manufacture.

The object of the invention is a method for manufacturing a rack comprising variable-pitch toothing, characterized in that it comprises a blank-forming step in which a blank of the rack is produced, said blank comprising at least an additional thickness on at least one area of the toothing with respect to a desired dimensional characteristic of the rack, the method also comprising a finishing step in which the at least one additional thickness of the blank is removed.

A blank of the rack is a rack comprising at least one additional thickness over at least one area of the toothing. The blank necessarily comprises a surplus of material which can be removed so as to achieve the desired dimensional characteristics. In no case does the blank show lack of material. In other words, the blank does not meet the desired dimensional characteristics because it has excess material. The blank could not be used as it is in a power steering system, for example. The method used during the blank-forming step is easily adjustable because it does not seek to produce a rack having all the desired dimensional characteristics. There are therefore more degrees of freedom than in a conventional method which directly produces a rack to the expected standard. The used setting makes it possible to quickly produce a blank of a rack comprising variable-pitch toothing.

The method used during the blank-forming step is selected according to technical and economic constraints.

Preferably, the blank of the rack will be produced by means of a machining method implementing a machine-tool. A machining method removes material. Such a method seeking to produce only a blank is easily adjustable and makes it possible to quickly produce a large number of parts. According to one embodiment, said machine tool comprises at least five control axes.

The finishing step is independent of the selected method to produce the blank of the rack during the blank-forming step.

The finishing step is carried out following the blank-forming step.

The finishing step removes the additional thickness of the blank by a method which may be different from that implemented for the production of the blank.

Thus, the finishing step makes it possible to produce a rack comprising a complex form of toothing, with a method that is simple to adjust and to produce.

The method according to the invention advantageously combines a method making it possible to obtain a blank and a finishing step, both easily adjustable, so as to manufacture a rack comprising a variable-pitch toothing having high dimensional precision. The method according to the invention therefore makes it possible to reduce the duration of the method for manufacturing the rack.

According to one characteristic of the invention, the at least one additional thickness is comprised between 0.02 mm and 1 mm.

The additional thicknesses are homogeneous because they are all comprised in a range of restricted values with respect to the size of the rack.

Thus, the blank comprises dimensional characteristics close to those desired and the finishing step only needs to remove a small amount of material. The method implemented during the finishing step and its adjustment are therefore adapted to the range of values in which the additional thicknesses are comprised.

According to one characteristic of the invention, the at least one additional thickness is comprised between 0.02 mm and 0.11 mm.

According to one characteristic of the invention, the finishing step is carried out by means of a broach method implementing a broach tool.

The use of a broach method limits an amount of material that can be removed with each passage of the broach tool. Thus, the finishing step must be carried out after the blank-forming step when the amount of material to be removed is small.

The finishing step uses a broach method which has the advantage of being easily adjustable and which makes it possible to quickly reach, that is to say by a reduced number of passages of the broach tool on the blank, the desired dimensional characteristic for the rack. Preferably, the finishing step will only require a single pass of the broach tool.

The broach tool is designed to travel the blank over its entire length in order to precisely remove the additional thickness that may be present on the toothing.

According to one characteristic of the invention, the broach method is a helical broach method.

A helical broach method makes it possible to create more complex shapes than a traditional broach method.

A helical method implements a rotary broach tool. In this way, it is possible to easily produce the flanks of the teeth having a non-constant helix angle.

Thus, the helical broach method is particularly suitable for a rack with variable-pitch toothing.

According to one characteristic of the invention, the finishing step comprises a positioning phase in which the broach tool is positioned relative to the blank of the rack so as to form a predetermined angle.

The positioning phase corresponds to positioning the blank relative to the broach tool.

The predetermined angle depends on an orientation of the toothing to be produced. The toothing to be produced depends directly on the pinion with which it is intended to cooperate.

According to one characteristic of the invention, the predetermined angle is equal to the angle formed between the rack and the pinion with which it is intended to cooperate.

According to one characteristic of the invention, the predetermined angle is comprised between 70° and 85°, or between 75° and 80°.

Thus, the predetermined angle is adapted to manufacture a rack of a power steering system of a vehicle and therefore to cooperate with a steering pinion of a vehicle. According to one characteristic of the invention, the finishing step comprises a broach phase in which the broach tool performs a rotational movement along an axis of rotation extending along a length of the broach tool.

After the positioning phase, the finishing step comprises a broach phase during which the additional thickness is removed.

For this, the broach tool, in contact with the blank, performs a rotational movement so as to cover a length of the toothing of the blank. During its passage at the level of each tooth, the broach tool removes a small amount of material corresponding to the additional thickness.

According to one characteristic of the invention, during the broach phase, the broach tool performs a translation movement along a translation axis extending along the length of the broach tool.

The translational movement associated with the rotational movement enables the broach tool to travel a length of the toothing of the blank and thus to eliminate the additional thicknesses of each of the teeth.

According to one characteristic of the invention, during the broach phase, the blank of the rack performs a translational movement along an axis extending along a length of the blank of the rack.

The translational movement associated with the rotational movement enables the broach tool to travel over a length of the toothing of the blank and thus to eliminate the additional thicknesses of each tooth. The translational movement can be carried out partly by the rack and partly by the broach tool.

According to one characteristic of the invention, during the broach phase, a translation speed of the blank of the rack or a translation speed of the broach tool or a rotation speed of the broach tool is variable.

Thus, the relative movement of the blank and of the broach tool varies so as to create a variable-pitch toothing.

According to one characteristic of the invention, the speed of translation of the blank of the rack or the speed of translation of the broach tool is correlated to the speed of rotation of the broach tool according to a broach curve corresponding to a reduction ratio between the rack and a pinion with which it is intended to cooperate.

The broach curve represents the speed of translation of the blank of the rack or the speed of translation of the broach tool as a function of a speed of rotation of the broach tool. The broach curve is similar to a curve of the reduction ratio representing a reduction coefficient of the variable-pitch rack as a function of a rotation of the pinion with which it is intended to cooperate.

Thus, the broach tool travels over the blank with a movement similar to the movement of the pinion with which the rack is intended to cooperate. In this way, the broach tool removes the material exactly in the areas which will hinder subsequent operation of the pinion/rack couple.

The finishing step is therefore carried out by a broach tool reproducing the movement of the pinion on the rack. The adjustment is therefore particularly easy.

The invention also relates to a broach tool allowing the implementation of the manufacturing method according to the invention, comprising at least one helical flute extending over a length of the broach tool, said flute corresponding to a groove of a pinion with which the rack is intended to cooperate.

The broach tool comprises a flute which reproduces the pinion with which the rack is intended to cooperate. The broach tool reproduces exactly a movement of the pinion on the rack.

The broach step using such a tool is therefore particularly easy to implement because it reproduces the subsequent operation of the rack.

Thus, the machining of the rack is perfectly adapted to the subsequent envisaged use.

According to one characteristic of the invention, said flute corresponding to a trace of a groove of a pinion when said pinion performs a rotational movement coupled to a translational movement on the rack.

Thus, the flute extends helically over the entire length of the broach tool. The broach tool is suitable for producing helical broach. The invention will be better understood, thanks to the description below, which relates to an embodiment according to the present invention, given by way of non-limiting example and explained with reference to the appended diagrammatic drawings, in which:

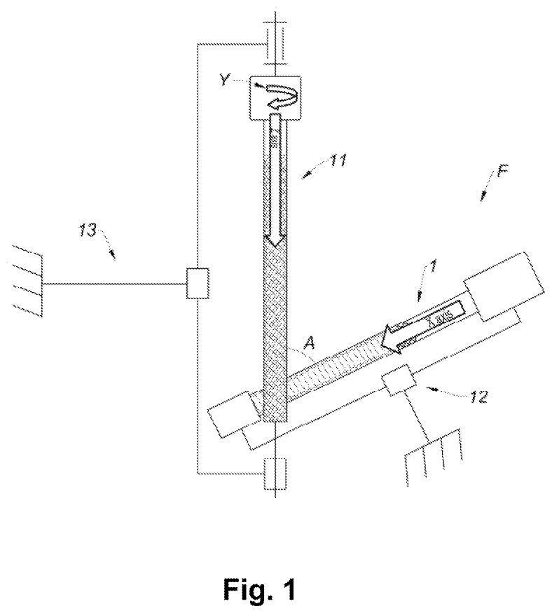

FIG. 1 is a representation at a first instant of a finishing step of a method according to the invention;

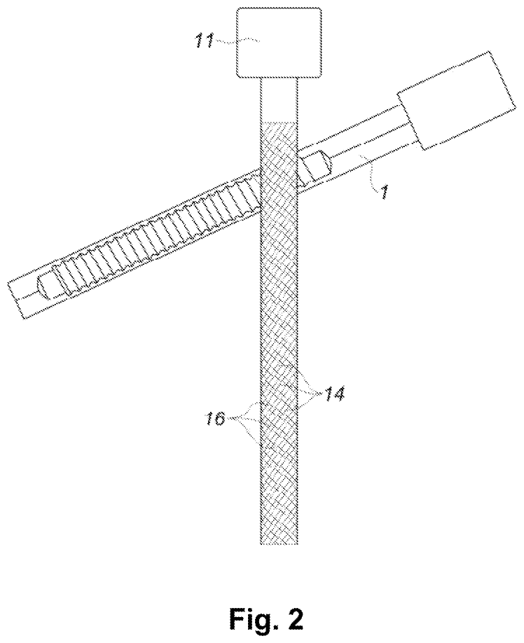

FIG. 2 is a representation at a second instant of the finishing step of the method according to the invention;

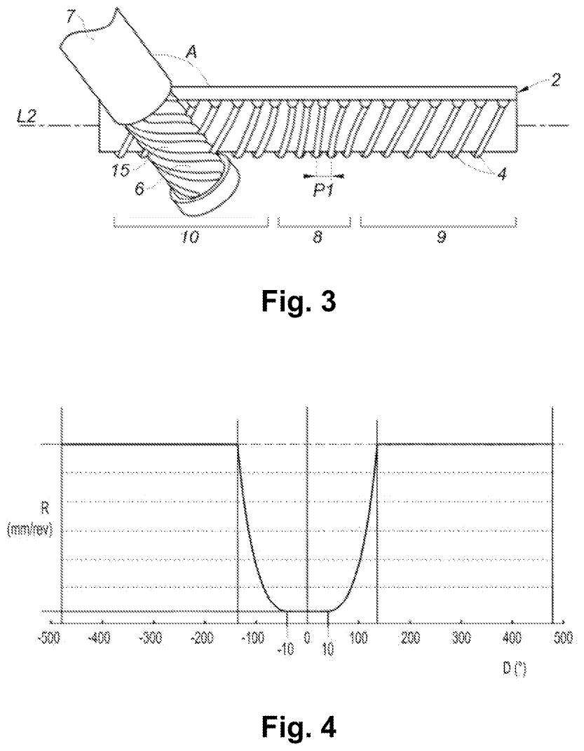

FIG. 3 illustrates, in a schematic perspective view, a portion of a power steering mechanism for a vehicle comprising a pinion which meshes with a rack with variable-pitch toothing manufactured according to the method which is the object of the invention;

FIG. 4 is a representation of a broach curve used by a method according to the invention.

The invention concerns a method for manufacturing a rack 2 comprising a toothing with variable pitch P1 implementing two distinct steps comprising a blank-forming step then a finishing step F.

During the blank-forming step, the blank 1 of the rack 2 is made using, for example, a machining method. The term «machining method» means a method for removing material by cutting chips by means of a moving cutting tool, preferably a rotating cutting tool such as a milling cutter, which is driven in rotation around its own central axis to achieve a cutting effect.

The blank-forming step produces a blank 1 of the rack 2, that is to say a rack 2 which comprises additional thicknesses on an area of the toothing. Thus, the blank 1, due to the presence of excess material, is not conform to the dimensional characteristics desired for the rack 2. The blank 1 cannot therefore be used directly in a vehicle power steering system.

The production of the blank 1 requiring less precision than the direct production of the rack 2, an adjustment of the machining tool used by the machining method is facilitated. Thus, the method according to the invention makes it possible to reduce a time necessary for adjusting the machining tool.

The blank 1 is made by cutting a toothing in a rectilinear bar, preferably metal for problems of mechanical strength during the use of the rack 2. The toothing extends substantially transversely to a length L2 of the bar.

The toothing has a variable pitch P1, that is to say that the interval P1 which axially separates two successive teeth 4 varies according to the position and the curvature of said teeth 4 along the length L2 of the bar.

This makes it possible in particular to vary the reduction ratio R of the rack 2 as a function of the considered meshing area 8, 9, 10.

Thus, in the example of a steering mechanism for a vehicle, such as that illustrated in FIG. 3, in which the rack 2 meshes with a pinion 6, itself driven for example by an assistance motor and/or or by a steering column 7 connected to a steering wheel. It is possible to provide a short pitch P1 in the middle area 8 of the rack 2, so as to obtain greater precision of the steering manoeuvres in the vicinity of the straight line, then to increase the pitch P1 when moving away from the middle area to the end areas 9, 10 of the rack 2, so as to accelerate large-scale movements, in particular during parking manoeuvres. The difference in behaviour of the steering movements in the middle area 8 and the extreme areas 9, 10 is represented by a curve of the reduction ratio as illustrated in FIG. 4.

The curve of the reduction ratio R illustrates a reduction coefficient of the rack 2 with variable pitch as a function of a rotation D of the pinion 6. For a rotation angle D of the pinion 6 comprised between −10° and 10°, that is to say in the middle area 8, the reduction ratio R is substantially constant in order to promote driving precision and the steering wheel feeling in a straight line. Whereas for rotation angles D of the pinion 6 comprised substantially between −10° and −130° and 10° and 130°, that is to say in the extreme areas 8, 9, the reduction ratio D increases greatly thus making it possible to favour the trajectory of the vehicle.

After the completion of the blank-forming step, the method according to the invention implements a finishing step F comprising a positioning phase then a broach phase.

The positioning phase consists of positioning the blank 1 previously produced facing a broach tool 11 with a view to carrying out the broach phase. For this, the blank 1 is fixed on a first sliding carriage 12 so that the blank 1 can perform a translational movement along an axis X extending along the length of the blank 1 of the rack 2.

Furthermore, the broach tool 11 is mounted on a second carriage 13 so as to allow a rotational movement along an axis of rotation Y extending along a length of the broach tool and a translational movement along an axis of translation Z also extending along the length of the broach tool 11.

The broach tool 11 comprises a plurality of helical flutes 14 extending over the length of the broach tool 11. More precisely, the flutes 14 correspond to a trace of the grooves 15 of the pinion 6 with which the rack 2 is intended to cooperate, when the pinion 6 travels over the rack 2. In other words, the flutes 14 of the broach tool 11 are identical to the grooves 15 of the pinion 6 when the latter are extended over the entire length of the broach tool 11. The flutes 14 have cutting edges capable of notching and removing the material in which the blank 1 is made.

The broach tool 11 also comprises grooves 16 extending substantially transversely to the flutes 14. The purpose of the grooves 16 is to evacuate the elements or shavings of material cut by the flutes 14.

During the positioning phase, and as represented in FIG. 1, the broach tool 11 is positioned at a first end of the blank 1.

Furthermore, the broach tool 11 and the blank 1 of the rack 2 form a predetermined angle A corresponding to the angle formed between the rack 2 and the pinion 6 with which it is intended to cooperate.

Following the positioning phase, the finishing step carries out the broach phase as illustrated in FIG. 2, in which the additional thicknesses of the blank 2 are removed by the broach tool.

During the broach phase, the broach tool 11 is brought into contact with the blank 1 so as to engage the broach tool 11 on the blank 1 in the manner of the pinion 6 on the rack 2.

The broach tool 11 then performs a movement of translation and rotation while the blank 1 performs a movement of translation. Thus, the broach tool 11 travels over the toothing of the blank 1 in the manner of the pinion 6 on the rack 2. When the broach tool 11 arrives at the level of the second end of the blank 1, the entire length of the broach tool 11 has passed through the blank 1 so that the whole of the blank 1 has been travelled by the broach tool 11.

The translation speed of the blank 1 of the rack 2 or the translation speed of the broach tool 11 is correlated to the rotation speed of the broach tool 11 according to a broach curve similar to the curve of the reduction ratio illustrated in FIG. 4.

Thus, the broach tool 11 travels over the blank 1 with a movement similar to the movement of the pinion 6 on the rack 2. In this way, the broach tool 11 removes the material exactly in the areas which will hinder subsequent operation of the pinion 6/rack 2 couple.

After the completion of the broach phase, the blank 1 no longer comprises any additional thickness. The blank 1 has become a rack 2 which can be installed in a power steering system of a vehicle.

According to one characteristic of the invention, the broach phase is carried out after a heat treatment phase. Indeed, during the latter, deformations can occur such as swelling and twisting of the rack, in particular when the rack has significant helix angles. Thus, carrying out the broach phase after the heat treatment phase advantageously confers the geometric quality of the flanks.

Of course, the invention is not limited to the embodiments described and represented in the appended figures. Modifications remain possible, in particular from the point of view of the constitution of the various elements or by substitution of technical equivalents, without thereby departing from the scope of protection of the invention.

1. A method for manufacturing a rack comprising a variable-pitch toothing, comprising a blank-forming step in which a blank of the rack is produced, the blank comprising at least one additional thickness on at least one area of the toothing with respect to a desired dimensional characteristic of the rack, wherein the method also comprises a finishing step carried out by means of a helical broach method using a broach tool in which the at least one additional thickness of the blank is removed.

2. The manufacturing method according to claim 1, wherein the at least one additional thickness is comprised between 0.02 mm and 1 mm.

3. The manufacturing method according to claim 1, wherein the finishing step comprises a positioning phase in which the broach tool is positioned with respect to the blank of the rack so as to form a predetermined angle.

4. The manufacturing method according to claim 1, wherein the finishing step comprises a broach phase in which the broach tool performs a rotational movement along an axis of rotation extending along a length of the broach tool.

5. The manufacturing method according to claim 4, wherein, during the broach phase, the broach tool performs a translational movement along a translation axis extending along the length of the broach tool.

6. The manufacturing method according to claim 4, wherein, during the broach phase, the blank of the rack performs a translational movement along an axis extending along a length of the blank of the rack.

7. The manufacturing method according to claim 1, wherein, during the broach phase, a translation speed of the blank of the rack or a translation speed of the broach tool or a rotation speed of the broach tool is variable.

8. The manufacturing method according to claim 7, wherein the speed of translation of the blank of the rack or the speed of translation of the broach tool is correlated to the speed of rotation of the broach tool according to a broach curve corresponding to a reduction ratio between the rack and a pinion with which it is intended to cooperate.

9. A broach tool allowing the implementation of the manufacturing method according to claim 1 comprising at least one helical flute extending over a length of the broach tool, the flute corresponding to a groove of a pinion with which the rack is intended to cooperate.
